(19) United States
(12) Patent Application Publication
(10) Pub. No.: US 2008/0153026 A1
(43) Pub. Date: Jun. 26, 2008

(54) Graphite containing carriers

(75) Inventors: Brian S. Giannetto, Livonia, NY (US); Samir Kumar, Pittsford, NY (US); Thomas J. Budny, Penfield, NY (US); Brian E. Moore, Ontario, NY (US); John G. Wise, Rochester, NY (US); D. Paul Casalmir, Sodus, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/643,400

(22) Filed: Dec. 21, 2006

(51) Int. Cl. G03G 9/083

(52) U.S. Cl. 430/111.32; 430/137.13

(57) ABSTRACT

A carrier containing a core, a polymer coating, mixtures of polymers, or a plurality of polymers thereover, and wherein at least one of, and more specifically, one of the coating polymers, includes graphite.

### BACKGROUND

There are disclosed herein carrier particles that can be selected as developer compositions in a number of copying and printing processes, such as xerographic processes, digital imaging processes, and the like. More specifically, there are disclosed carrier particles comprised of a carrier core, at least one polymer, such as from one to about 5, coating thereover, and mixed with or dispersed in the polymer coating graphite, and wherein the resulting carriers are rendered conductive, for example, there can be achieved a carrier conductivity of from about 10⁻⁶ to about 10⁻¹² ohm-cm)⁻¹.

Also included within the scope of the present disclosure are methods of imaging and printing with the carriers illustrated herein. These methods generally involve the formation of an electrostatic latent image on an imaging member or photoconductor, followed by developing the image with a developer comprised of a toner composition comprised, for example, of thermoplastic resin, colorant, such as pigment, charge additive, and surface additive, reference U.S. Pat. Nos. 4,560,635; 4,298,697 and 4,338,390, the disclosures of which are totally incorporated herein by reference, and the graphite containing carrier particles illustrated herein; subsequently transferring the image to a suitable substrate, and permanently affixing the image thereto. In those environments wherein the process is to be used in a printing mode, the imaging method involves the same aforementioned operation with the exception that exposure can be accomplished with a laser device or image bar. Yet, more specifically, the graphite containing carrier particles and developers disclosed herein can be selected for the Xerox Corporation iGEN3® machines that generate with some versions over 100 copies per minute. Processes of imaging, especially xerographic imaging and printing, including digital and/or color printing, are thus encompassed by the present disclosure. Moreover, the graphite containing carriers of this disclosure are useful in high speed color xerographic applications, particularly high speed color copying and printing processes.

### REFERENCES

In U.S. Pat. No. 6,660,444 there is disclosed, for example, a carrier comprised of a core, a number of the pores thereof containing a polymer, and thereover a polymer mixture coating, such as PMMA and PVF (polyvinylidene fluoride), and where the polymer coating can contain a conductive additive like carbon black, metal oxides and iron powder, the primary purposes of the conductive additive being to increase the conductivity of the carrier.

In U.S. Pat. No. 7,014,971 there is disclosed, for example, a carrier comprised of a mixture of a first and second carrier, which carriers may contain a polymer coating and present in the polymer coating carbon black.

Disclosed in U.S. Pat. No. 6,391,509 is a carrier containing a core, a polymer coating, or mixtures of polymers thereover, and where the coating polymer or mixtures thereof contains a conductive polymer. This patent also discloses a carrier containing as a coating a mixture of a polymer and carbon black, see for example Comparative Example 1.

Illustrated in U.S. Pat. No. 5,518,855 is a dry process for the preparation of conductive carrier particles where there can be mixed a carrier core with a first and second polymer pair each containing an insulating polymer and a conductive polymer, and where the carrier polymer coating can contain dispersed therein carbon black.

Also, illustrated in U.S. Pat. No. 6,004,712 are carriers, coated carriers, and developers thereof, and where the carrier coating may contain a conductive component, such as carbon black, therein.

Thus, developer compositions with coated carriers that contain certain conductive additives like carbon blacks are known. Disadvantages associated with these carriers may be that the carbon black and other similar additives can decrease the carrier triboelectric charge values; cause toner and developer contamination; increase the brittleness of the polymer matrix, which causes the separation of the coating from the core, and thereby contaminates the toner and developer resulting in, for example, instabilities in the charging level of the developer as a function of a number of factors, such as the developer age in the xerographic housing and the average toner area coverage of a printed page, or instabilities in the color gamut of the developer set. These and other disadvantages are avoided, or minimized with the carriers of the present disclosure in embodiments thereof.

There are illustrated in U.S. Pat. No. 4,233,387 coated carrier components for electrostatographic developer mixtures comprised of finely divided toner particles clinging to the surface of the carrier particles. Specifically, there are disclosed in this patent coated carrier particles obtained by mixing carrier core particles of an average diameter of from between about 30 microns to about 1,000 microns with from about 0.05 percent to about 3 percent by weight, based on the weight of the coated carrier particles, of thermoplastic resin particles. The resulting mixture is then dry blended until the thermoplastic resin particles adhere to the carrier core by mechanical impaction, and/or electrostatic attraction. Thereafter, the mixture is heated to a temperature of from about 320° F. to about 650° F. for a period of 20 minutes to about 120 minutes enabling the thermoplastic resin particles to melt and fuse on the carrier core. While the developer and carrier particles prepared in accordance with the process of this patent are suitable for their intended purposes, the conductivity values of the resulting particles are not believed to be constant in all instances, for example, when a change in carrier coating weight is accomplished to achieve a modification of the triboelectric charging characteristics. With the disclosure of the present application, in embodiments thereof the tribo of the resulting carrier particles are in embodiments substantially constant, and moreover, the conductivity values can be selected to vary from, for example, about 10⁻⁶ to about 10⁻¹² (ohm-cm)⁻¹, and the like, depending, for example, on the polymer mixture selected for affecting the coating processes.

Also mentioned are Japanese Publications JP02163759, JP02236568 and JP01211770, which apparently disclose graphite containing acrylic resins.

The disclosures of each of the above U.S. patents are totally incorporated herein by reference. The appropriate toners, carrier cores, carrier coating processes and polymer coatings of these patents may be selected for the graphite containing coated carriers disclosed herein in embodiments thereof.

### SUMMARY

Disclosed are toner and developer compositions with many of the advantages illustrated herein, such as minimizing a decrease in triboelectric charge; avoiding or minimizing color contamination of the toner present in the developer mix; enabling tunable conductivity characteristics; permitting carrier particles with substantially preselected constant triboelectric charging values, and a wide range of preselected conductivity parameters. Also, disclosed are conductive carrier particles comprised of a coating generated from a mixture of monomers that, for example, are not in close proximity in the triboelectric series, that is, for example, a mixture of monomers from different positions in the triboelectric series, and wherein the resulting coating has incorporated therein, or present therein or thereon a conductive graphite; carrier particles with improved mechanical characteristics; graphite containing carriers wherein the conductivity thereof is tunable by, for example, adjusting the concentration or amount of graphite selected; carriers wherein the coating adheres to the core wherein there is minimal or no separation of the polymer coating from the core while minimizing the amount of conductive graphite component selected for the carrier coating to maintain a constant triboelectric charge thereof; increasing carrier conductivity while simultaneously minimizing or avoiding adverse effects on the triboelectric characters of a developer comprised of carrier and the toner.

Additionally, in embodiments there are provided carriers and developers thereof with substantially no shift in Delta E, especially in those situations where the toner contains a yellow colorant. Delta E refers to the amount of toner contamination, the lower the Delta E, the lower the toner contamination, which contamination of the toner is caused primarily by the surface of the carrier that is exposed and conductive additives in the carrier coating. With black additives like carbon black, noting that graphite usually possesses a grayish color, added to the carrier coating, the contamination is believed to be caused by both the additives in the carrier coating and the portion of the carrier that remains uncoated. These and other disadvantages are avoided or minimized with the graphite-coated carrier of the present disclosure. More specifically, the toner color or the color gamut is substantially unaffected with the graphite-coated carriers.

Delta E allows the mathematical determination of the Euclidean distance between two colors in the three-dimensional CIELAB color space. The Delta E is the difference in the color between toner that was not aged (uncontaminated toner) and toners that had been aged (contaminated toner). Toners can be aged with carrier in which the formulation contains conductive additives, such as carbon black, graphite, and no conductive additives by placing the developer materials in an 8 ounce glass jar with 4.5 percent by weight of a toner composition, and agitating for 40 minutes on a Red Devil Paint Shaker. Subsequently, the toner can be separated from the carrier using an Alpine sieve and by a wet deposition method; the toner can then be placed onto a media where the CIELAB values (L*, a* and b*) can be obtained using a spectrophotometer. Delta E is then calculated using the following equation

\sqrt{(L₁−L₂)²+(a₁−a₂)²+(b₁−b₂)²}

where L, a and b is a three-dimensional calorimetric space where the L coordinate defines the color lightness dimension, the a coordinate defines the color transition between red and green, and the b coordinate defines the color transition between yellow and blue.

Delta E values of toners aged with carriers containing graphite were unchanged in comparison to toners that were aged with carriers that contained no conductive additives. This was not the situation for toners aged with carriers that contained conductive additives, such as carbon black, as illustrated in the following table. The toner selected was, for example, an 8.3 micron volume median diameter. (volume average diameter) yellow toner comprised of POLYTONE-Y yellow 17™ pigment, the polytone being a partially crosslinked (about 32 percent) polyester resin obtained by the reactive extrusion of a linear bisphenol A propylene oxide fumarate polymer. The toner compositions contained as external surface additives 1.6 percent by weight of hydrophobic 40 nanometer size titania, 4.5 percent by weight of 30 nanometer size hydrophobic silica, 0.1 percent by weight of 12 nanometer size hydrophobic silica, and 0.5 weight percent of zinc stearate. The final toner composition had a melt flow index of 6.

| | PERCENT | RATIO OF | |
|---|---|---|---|
| CONDUCTIVE | COATING | ADDITIVE TO | DELTA E |
| ADDITIVE | WEIGHT | BINDER RESIN | VALUE |
| EEONOMER ® 200F; | 1 percent | 0.1 | 12.32 |
| Carbon Black | | | |
| Graphite | 1 percent | 0.1 | 0.59 |
| No Additives | 1 percent | 0 | 1.60 |

Aspects of the present disclosure relate to carrier particles with a graphite containing coating thereover generated from a mixture of graphite and a polymer or polymers, and wherein the carrier triboelectric charging values are from about −75 to about 75 microcoulombs per gram at the same coating weight as determined by the known Faraday Cage technique; positively charged toner compositions, or negatively charged toner compositions having incorporated therein metal or metal oxide carrier particles with a coating thereover of at least one suitable polymer, and which coating contains graphite; a carrier comprised of a core, at least one polymer coating, and wherein the coating contains graphite; a carrier wherein the polymer coating is comprised of a mixture of polymers containing a known graphite dispersed therein; carrier comprised of a suitable know carrier core, a polymer coating, and wherein the coating contains graphite; a carrier wherein the polymer coating is comprised of a mixture of polymers; a carrier wherein the polymer mixture is comprised of 2 polymers; a carrier wherein the polymer mixture is comprised of about 2 to about 5, and more specifically, 2 polymers not in close proximity in the triboelectric series; a carrier wherein the polymer mixture is comprised of from about 2 polymers to about 7 polymers; a carrier with at least one polymer coating wherein at least one is 1, 2, or 3, and more specifically, 1; a carrier wherein the graphite selected is commercially available from Eeonyx Corporation, as Graphine EEONOMER® G; a carrier wherein the graphite is, for example, of a primary size diameter of from about 1 to about 5 microns; a carrier wherein the graphite is, for example, of a primary size diameter of from about 300 nanometers to about 7 microns, from about 1 to about 5 microns, and more specifically, from about 1 to about 3 microns, and which graphite is present in an amount of from about 1 percent by weight to about 70 percent by weight based on the weight percent of the total of the at least one polymer coating and the graphite; a carrier wherein the graphite is present in an amount of from about 5 percent by weight to about 25 percent by weight, or from about 10 percent by weight to about 20 percent by weight; a carrier wherein the carrier core diameter is from about 30 to about 100 microns; a carrier wherein the core is iron, steel or a ferrite; a carrier wherein the coating polymer is a styrene polymer; a carrier wherein the polymer coating is sodium lauryl sulfate (SLS) polymethylmethacrylate or a polymethylmethacrylate polymer or copolymer formed by polymerizing monomers in the presence of a surfactant, in particular in the presence of sodium lauryl sulfate; a carrier where the polymer coating polymethylmethacrylate polymer or copolymer is generated in the presence of a surfactant, such as sodium lauryl sulfate, resulting in a polymethylmethacrylate polymer or copolymer having an average particle size of less than about 100 nanometers, such as from about 15 to about 50 nanometers; a carrier with a graphite containing polymer coating of polyvinylidenefluoride, polyethylene, polymethyl methacrylate, polytrifluoroethyl methacrylate, copolyethylene vinylacetate, copolyvinylidenefluoride, tetrafluoroethylene, polystyrene, polyvinyl chloride, polyvinyl acetate, or mixtures thereof; a carrier wherein the polymer coating is a polymethylmethacrylate (PMMA), polystyrene, polytrifluoroethyl methacrylate, or mixtures thereof; a carrier wherein the polymer coating is comprised of a mixture of polymethyl methacrylate and polytrifluoroethyl methacrylate; a carrier wherein the polymer coating is present in a total amount of from about 0.5 to about 10 percent by weight of the carrier, or from about 1 to about 5 percent by weight of the carrier; a carrier with a conductivity of from about 10⁻¹⁵ to about 10⁻⁴ (ohm-cm)⁻¹; coated graphite containing carriers with conductivities as determined in a magnetic brush conducting cell of from about 10⁻⁶ (ohm-cm)⁻¹ to about 10⁻¹⁵ (ohm-cm)⁻¹, more specifically, from about 10⁻¹⁰ (ohm-cm)⁻¹ to about 10⁻⁶ (ohm-cm)⁻¹, and yet more specifically, from about 10⁻⁹ (ohm-cm)⁻¹ to about 10⁻⁷ (ohm-cm)⁻¹; and a carrier with a triboelectric charge value of from about 25 to about 55 microcoulombs/gram and a conductivity of from about 10⁻¹² to about 10⁻⁶ (ohm-cm)⁻¹.

A specific polymer coating or coatings can be comprised of a thermosetting polymer and, yet more specifically, a poly(urethane) thermosetting resin which contains, for example, from about 75 to about 95, and more specifically, about 80 percent by weight of a polyester polymer, which when combined with an appropriate crosslinking agent, such as isopherone diisocyannate, and initiator, such as dibutyl tin dilaurate, forms a crosslinked poly(urethane) resin at elevated temperatures. An example of a polyurethane is poly(urethane)/polyester polymer or ENVIROCRON™ (product number PCU10101, obtained from PPG Industries, Inc.). This polymer has a melt temperature of between about 210° F. and about 266° F., and a crosslinking temperature of about 345° F. A specific poly(urethane) polymer is mixed together with a first polymer, generally prior to mixing with the core, which when fused forms a uniform coating of the first and the specific thermosetting polymer on the carrier surface. The second thermosetting polymer is present, for example, in an amount of from about 0 percent to about 99 percent by weight, based on the total weight of the first and second polymers and the graphite dispersed therein.

The carrier polymer coating, or polymer coating mixture contains a conductive graphite as illustrated herein, and which graphite is, for example, of a primary particle size diameter of from about 1 to about 7 microns, examples of which are graphites available from Eeonyx Inc., Pinole, Calif., the ratio of the graphite to polymer coating being, for example, from about 5/95 to about 40/60, and more specifically, from about 10/90 to about 20/80 (about includes at least all values in between the values recited). The graphites, which are believed to be readily available, can in embodiments be prepared, it is believed, by third party proprietary electrochemical process. Typically a number of graphites are mechanically ground to approximately 20 to about 30 microns in diameter by a mechanical process, and which sizes can be larger than the known Eeonyx Inc. graphites.

Further, the pellet resistivity of graphite, such as Graphine EEONOMER® G, can be compared to other conductive additives, such as the carbon black EEONOMER® 200F (also available from Eeonyx Corp.,) by determining the percolation thresh point. EEONOMER® 200F is believed to be comprised of an intrinsically conductive polymer, such as a polypyrrole or a polyaniline polymer, deposited on a carbon black matrix, and which depositing is accomplished, for example, by an in situ polymerization. The graphite percolation thresh point is believed to be below about 3 percent, for example, from about 0.5 to about 3 percent by volume or lower, by about 5 percent to about 7 percent by volume than the EEONOMER® 200F, and also the graphite is more conductive than the EEONOMER® 200F.

The percolation threshpoint is, for example, the point where the materials (coated carrier) resistivity changes as illustrated by a very steep curve and becomes relatively conductive as the amount of conductive additive is increased. The percolation threshpoint can be determined by blending additive/polymer mixtures, such as by blending EEONOMER® 200F and polymethylmethacrylate at ratios where the percent by volume of EEONOMER® 200F is increased in small increments and the additive/polymer ratio is from about 3 percent to about 15 percent by volume of conductive polymer additive. The resistivities of the pellets resulting are then measured using the ASTM test method D257-90.

The graphite pressed pellets achieved a percolation at lower volume loading than pellets pressed using EEONOMER® 200F. The percent by volume of the conductive additive in the premix was then calculated using the true density of the materials. The point of percolation, see the following table, of the graphite and the EEONOMER® 200F is obtained from the volume resistivity response as a function of percent volume loading of conductive additive.

| CONDUCTIVE ADDITIVE | PERCOLATION THRESHPOINT |
|---|---|
| EEONOMER ® 200F | 6.5 Percent by Volume |
| Graphite | <3 Percent by Volume |

There results, in accordance with aspects of the present disclosure, carrier particles of tunable conductivities of from about 10⁻¹⁵ (ohm-cm)⁻¹ to about 10⁻⁶ (ohm-cm)⁻¹, and more specifically from about 10⁻¹⁰ (ohm-cm)⁻¹ to about 10⁻⁸ (ohm-cm)⁻¹ cm)⁻¹ at, for example, a 30 volt potential across a 0.1 inch gap containing carrier beads held in place by a magnet; and wherein the carrier particles are of a triboelectric charging value of from about −80 to about 80 microcoulombs per gram, and more specifically, from about −60 to about 60 microcoulombs per gram as determined by a Faraday Cage, these parameters being dependent on the carrier coatings selected, and the percentage of each of the polymers used, and the graphite.

With further reference in embodiments to the monomer mixture utilized to achieve the polymer or copolymer carrier coating, close proximity refers, for example, to the choice of the polymers selected as dictated by their position in the triboelectric series, therefore for example, one may select a first polymer with a significantly lower triboelectric charging value than the second polymer. For example, the triboelectric charge of a steel carrier core with a polyvinylidenefluoride coating is about −75 microcoulombs per gram. However, the same carrier, with the exception that there is selected a coating of polymethylmethacrylate, has a triboelectric charging value of about 40 microcoulombs per gram. More specifically, not in close proximity refers to first and second polymers that are at different electronic work function values, that is the polymers are not at the same electronic work function value; and further, the first and second polymers are comprised of different components. Additionally, the difference in electronic work functions in embodiments between the first and second polymer is, for example, at least 0.2 electron volt, and more specifically, is about 2 electron volts; and moreover, it is known that the triboelectric series corresponds to the known electronic work function series for polymers, reference “Electrical Properties of Polymers”, Seanor, D. A., Chapter 17, Polymer Science, A. D. Jenkins, Editor, North Holland Publishing (1972), the disclosure of which is totally incorporated herein by reference. Illustrative examples of polymer coatings that are not in close proximity in the triboelectric series are polyvinylidenefluoride and polyethylene; polymethylmethacrylate and copolyethylenevinylacetate; copolyvinylidenefluoride tetrafluoroethylene and polyethylene; polymethylmethacrylate and copolyethylene vinylacetate; polymethylmethacrylate and polyvinylidenefluoride; polystyrene and tetrafluoroethylene; polyethylene and tetrafluoroethylene; polyethylene and polyvinyl chloride; polyvinyl acetate and tetrafluoroethylene; polyvinyl acetate and polyvinyl chloride; polyvinyl acetate and polystyrene; and polyvinyl acetate and polymethyl methacrylate.

The percentage of each polymer present in the carrier coating mixture can vary depending on the specific components selected, the coating weight and the properties desired. Generally, the coated polymer mixtures contain from about 10 to about 90 percent of a first polymer, and from about 90 to about 10 percent by weight of a second polymer. More specifically, there are selected, for example, mixtures of polymers with from about 40 to about 60 percent by weight of a first polymer, and from about 60 to about 40 percent by weight of a second polymer.

Examples of monomers or comonomers which can be polymerized to form the polymer, polymer mixture coating, or a plurality of coatings on the carrier core surface in a polymer amount of, for example, from about 0.5 to about 10 percent, or from about 1 to about 5 percent by weight of carrier core include vinyl monomers like styrene, p-chlorostyrene, vinyl naphthalene, and the like; monocarboxylic acids and their derivatives, such as acrylic acid, methyl acrylate, ethyl acrylate, n-butyl acrylate, isobutyl acrylate, dodecyl acrylate, n-octyl acrylate, 2-chloroethyl acrylate, phenyl acrylate, methylalphachloracrylate, methacrylic acids, methyl methacrylate, ethyl methacrylate, butyl methacrylate, octyl methacrylate, acrylonitrile, methacrylonitrile, acrylamide and trifluoroethyl methacrylate, dicarboxylic acids having a double bond, and their derivatives, such as maleic acid, monobutyl maleate, dibutyl maleate, unsaturated monoolefins such as ethylene, propylene, butylene and isobutylene; vinyl halides such as vinyl chloride, vinyl bromide, vinyl fluoride; vinyl esters such as vinyl acetate, vinyl propionate, vinyl benzoate and vinyl butyrate; vinyl ethers, inclusive of vinyl methyl ether, vinyl isobutyl ether, and vinyl ethyl ether; vinyl ketones inclusive of vinyl methyl ketone, vinyl hexyl ketone and methyl isopropenyl ketone; vinylidene halides such as vinylidene chloride and vinylidene chlorofluoride; N-vinyl compounds such as N-vinyl indole and N-vinyl pyrrolidene; fluorinated monomers such as pentafluoro styrene, allyl pentafluorobenzene, and the like, other suitable known monomers, and mixtures thereof. The process for incorporating the polymer blend onto a carrier core can be sequential, a process in which one of polymers, when two polymers are selected, is fused to the surface in a first operation, and the second polymer is fused to the surface in a subsequent fusing operation. Alternatively, the process for incorporation can comprise a single fusing by heating the core and polymer blend coatings.

Various suitable solid core carrier materials can be selected, inclusive of known cores. Characteristic core properties include those that will enable the toner particles to acquire a positive or a negative charge, and carrier cores that will permit excellent flow properties in the developer reservoir present in the xerographic imaging apparatus. Also of value with regard to the carrier core properties are, for example, suitable soft magnetic characteristics that permit magnetic brush formation in magnetic brush development processes, and wherein the carrier cores possess desirable aging characteristics. Soft magnetic refers, for example, to a developer that develops an induced magnetic field only when exposed to an external magnetic field, and which field is immediately diminished when the external field is removed. Examples of carrier cores that can be selected include iron, iron alloys, steel, ferrites, magnetites, nickel, and mixtures thereof. Alloys of iron include iron-silicon, iron-aluminum-silicon, iron-nickel, iron-cobalt, and mixtures thereof. Ferrites include a class of magnetic oxides that contain iron as the major metallic component, and optionally a second metallic component including magnesium, manganese, cobalt, nickel, zinc, copper, and mixtures thereof. Specific carrier cores include ferrites containing iron, nickel, zinc, copper, manganese, and mixtures thereof, and sponge iron with a volume average diameter of from about 30 to about 100 microns, and more specifically, from about 30 to about 50 microns as measured by a Malvern laser diffractometer; ferrites such as Cu/Zn-ferrite containing, for example, about 11 percent copper oxide, 19 percent zinc oxide, and 70 percent iron oxide, available from D. M. Steward Corp. or Powdertech Corp., Ni/Zn-ferrite available from Powdertech Corp., Sr (strontium)-ferrite containing, for example, about 14 percent strontium oxide and 86 percent iron oxide, available from Powdertech Corp., and Ba-ferrite, magnetites, available for example from Hoeganaes Corp. (Sweden), nickel, mixtures thereof, and the like. More specifically, carrier cores include ferrites, and sponge iron, or steel grit with an average particle size diameter of from between about 30 microns to about 200 microns.

Examples of specific suitable processes selected to apply the graphite polymer blend, a mixture of the polymer blend, or a plurality of polymers, for example from about 2 to about 5, and more specifically 2 polymer coatings to the surface of the carrier particles include combining the carrier core material, the polymers and conductive graphite component by cascade roll mixing, or tumbling, milling, shaking, electrostatic powder cloud spraying, fluidized bed, electrostatic disc processing, and an electrostatic curtain. Following application of the polymers and the graphite, heating is initiated to permit flow out of the coating material over the surface of the carrier core. The concentration of the coating material powder particles, and the parameters of the heating may be selected to enable the formation of a continuous film of the coating polymers on the surface of the carrier core, or permit only selected areas of the carrier core to be coated.

Toners can be admixed with the carrier to generate developers. As one toner resin there can be selected the esterification products of a dicarboxylic acid and a diol comprising a diphenol, reference U.S. Pat. No. 3,590,000 the disclosure of which is totally incorporated herein by reference, reactive extruded crosslinked polyesters, such as those illustrated in U.S. Pat. No. 5,227,460, the disclosure of which is totally incorporated herein by reference, and the like. Specific toner resins include styrene/methacrylate copolymers; styrene/butadiene copolymers; polyester resins obtained from the reaction of bisphenol A and propylene oxide; and branched polyester resins resulting from the reaction of dimethylterephthalate, 1,3-butanediol, 1,2-propanediol and pentaerythritol. Other toner resins are illustrated in a number of U.S. patents including some of the patents recited hereinbefore. Generally, from about 1 part to about 5 parts by weight of toner are mixed with from about 10 to about 300 parts by weight of the carrier particles.

Numerous well known suitable colorants, such as pigments or dyes can be selected as the colorant for the toner including, for example, cyan, magenta, yellow, red, blue, carbon black, nigrosine dye, lamp black, iron oxides, magnetites, and mixtures thereof. The colorant, such as a suitable known carbon black, should be present in a sufficient amount to render the toner composition highly colored. Thus, the colorant particles can be present in an amount of from about 3 percent by weight to about 20, and more specifically, from about 3 to about 12 weight percent or percent by weight, based on the total weight of the toner composition, however, suitable lesser or greater amounts of colorant particles can be selected. Colorant includes pigment, dye, mixtures thereof, mixtures of pigments, mixtures of dyes, and the like.

When the colorant particles are comprised of magnetites, which are a mixture of iron oxides (FeO.Fe₂O₃), including those commercially available as MAPICO BLACK®, they are usually present in the toner composition in an amount of from about 10 percent by weight to about 70 percent by weight, and preferably in an amount of from about 20 percent by weight to about 50 percent by weight.

The resin particles are present in a sufficient, but effective amount, thus when 10 percent by weight of pigment, or colorant, such as carbon black, is contained therein, about 90 percent by weight of resin is selected. Generally, the toner composition is comprised of from about 85 percent to about 97 percent by weight of toner resin particles, and from about 3 percent by weight to about 15 percent by weight of colorant particles.

The developer compositions can be comprised of thermoplastic resin particles, graphite polymer containing carrier particles and as colorants, magenta, cyan and/or yellow particles, black, red, green, brown, violet, orange, and mixtures thereof. More specifically, illustrative examples of magentas include 1,9-dimethyl-substituted quinacridone and anthraquinone dye identified in the color index as Cl 60720, Cl Dispersed Red 15, a diazo dye identified in the color index as Cl 26050, Cl Solvent Red 19, and the like. Examples of cyans include copper tetra-4(octadecyl sulfonamido) phthalocyanine, X-copper phthalocyanine pigment listed in the color index as Cl 74160, Cl Pigment Blue, and Anthrathrene Blue, identified in the color index as Cl 69810, Special Blue X-2137, and the like; while illustrative examples of yellows are diarylide yellow 3,3-dichlorobenzidene acetoacetanilides, a monoazo pigment identified in the color index as Cl 12700, Cl Solvent Yellow 16, a nitrophenyl amine sulfonamide identified in the color index as Foron Yellow SE/GLN, Cl Dispersed Yellow 33, 2,5-dimethoxy-4-sulfonanilide phenylazo-4′-chloro-2,5-dimethoxy aceto-acetanilide, permanent Yellow FGL, and the like. The colorants, which include pigments, mixtures of pigments, dyes, mixtures of dyes, mixtures of dyes and pigments, and the like, are generally present in the toner composition in an amount of from about 1 weight percent to about 15 weight percent based on the weight of the toner resin particles.

For further enhancing the positive charging characteristics of the developer compositions illustrated herein, and as optional components, there can be incorporated therein known charge enhancing additives inclusive of alkyl pyridinium halides, reference U.S. Pat. No. 4,298,672, the disclosure of which is totally incorporated herein by reference; organic sulfate or sulfonate compositions, reference U.S. Pat. No. 4,338,390, the disclosure of which is totally incorporated herein by reference; distearyl dimethyl ammonium sulfate; metal complexes, E-88™, naphthalene sulfonates, quaternary ammonium compounds; and other similar known charge enhancing additives. These additives are usually incorporated into the toner or carrier coating in an amount of from about 0.1 to about 20 percent by weight, and preferably from about 1 to about 7 weight percent by weight.

The toner composition can be prepared by a number of known methods including emulsion aggregation, melt blending the toner resin particles, and pigment particles or colorants of the present disclosure followed by mechanical attrition. Other methods include emulsion aggregates spray drying, melt dispersion, dispersion polymerization, and suspension polymerization. In one dispersion polymerization method, a solvent dispersion of the resin particles, and the colorant particles are spray dried under controlled conditions to result in the desired product.

Moreover, the developer compositions of the present disclosure are particularly useful in electrostatographic imaging processes and apparatuses wherein there is selected a moving transporting component and a moving charging component; and wherein there is selected a deflected flexible layered imaging member, reference U.S. Pat. Nos. 4,394,429 and 4,368,970, the disclosures of which are totally incorporated herein by reference. Images obtained with the developer composition of the present disclosure in embodiments possessed acceptable solids, excellent halftones and desirable line resolution with acceptable or substantially no background deposits.

The present disclosure enables in embodiments carriers with a wide range of carrier conductivities, preselected triboelectric charging values, and small carrier size, for example from about 30 to about 100 microns, and more specifically, from about 30 to about 50 microns in volume average diameter as determined by a Malvern laser diffractometer. Further, when the graphite resin coated carrier particles are prepared by the polymerization process of the present disclosure, the majority, that is, over about 90 percent of the coating materials, such as polymer, or polymers, are fused to the carrier surface thereby reducing the number of toner impaction sites on the carrier material. Additionally, there can be achieved with the process of the present disclosure, independent of one another, desirable triboelectric charging characteristics and excellent conductivity values, that is, for example the triboelectric charging parameter is not primarily dependent on the carrier coating weight as is believed to be the situation with the process of U.S. Pat. No. 4,233,387, wherein an increase in coating weight on the carrier particles may function to also permit an increase in the triboelectric charging characteristics. Specifically, therefore, with the carrier compositions and process of the present disclosure there can be formulated developers with selected triboelectric charging characteristics and/or conductivity values in a number of different combinations.

Accordingly, for example, there can be formulated in accordance with the disclosure of the present application carriers with conductivities of from about 10⁻¹⁵ (ohm-cm)⁻¹ to about 10⁻⁶ (ohm-cm)⁻¹, or from about 10⁻¹² (ohm-cm)⁻¹ to about 10⁻⁸ (ohm-cm)⁻¹ with a 30 volt bias as determined in a magnetic brush conducting cell; and triboelectric charging values of from about 80 to about −80 microcoulombs per gram, and preferably from about 60 to about −60 microcoulombs per gram, on the carrier particles as determined by the known Faraday Cage technique. The developers of the present disclosure can be formulated with constant triboelectric charge value with different conductivity characteristics by, for example, maintaining the same coating weight on the carrier particles and changing the polymer coating ratios. Similarly, there can be formulated developer compositions wherein constant triboelectric charging values are achieved, and the conductivities are altered by retaining the polymer ratio coating constant, and modifying the coating weight for the carrier particles.

The following Examples are being provided to further illustrate the present disclosure, it being noted that these Examples are intended to illustrate and not limit the scope of the present disclosure. Parts and percentages are by weight unless otherwise indicated.

More specifically, the conductivity values were generated by the formation of a magnetic brush with the prepared carrier particles. The brush was present within a one electrode cell of the magnet as one electrode, and a nonmagnetic steel surface as the opposite electrode. A gap of 0.100 inch was maintained between the two electrodes and a 30 volt bias was applied in this gap. The resulting current through the brush was recorded, and the conductivity can be calculated based on the measured current and geometry. Thus, conductivity in mho-cm⁻¹, which is the reciprocal of (ohm-cm)⁻¹, is the product of the current, and the thickness of the brush, about 0.254 centimeters divided by the product of the applied voltage and the effective electrode area.

With respect to the triboelectric values in microcoulombs per gram, they were determined by placing the developer materials of toner, 4.5 percent by weight, and coated carrier in a 4 ounce glass jar, on a Red Devil Paint Shaker followed by agitation for 20 minutes. Subsequently, the jar was removed and samples from the jar were placed in a known tribo Faraday Cage apparatus. The blow off tribo of the carrier particles was then measured.

Materials refers primarily to the core/polymer mixture product.

### EXAMPLE I

### Preparation—Measurement of Pellet Resistivity

To determine the volume resistivity of a pellet of 5 percent by volume of EEONOMER® 200F, (EEONOMER® 200F is believed to be comprised of an intrinsically conductive polymer, such as a polypyrrole or a polyaniline polymer, deposited on a carbon black matrix), a mixture of EEONOMER® 200F and polymethylmethacrylate was prepared utilizing a mixing device, available from Bepex Corp., Minneapolis, Minn. (Model #NHS-0). The conductive additive/polymer premix was prepared by adding to a 300 cc cup in the mixing device 2.75 grams of EEONOMER® 200F and 35.92 grams of polymethylmethacrylate, and where the hybridizer propeller speed was 1,300 rpm for 2 minutes.

To press the pellet, the resistivity pellet die holes were filled with 0.8 cc (true density of the powder used to calculate this volume) of the above generated powder mixture. Utilizing a die press capable of 7,000 PSI pressure, the press was pumped until 5,000 PSI pressure ±100 PSI was applied to the die. This pressure was maintained for 5 minutes. Rubber gloves were utilized to measure the pellets dimensions to minimize or prevent skin oils and salts from affecting the resistivity measurement of the pellets. Once the pellets were removed from the die, the edges of the pellets were gently trimmed free of any mold flanges with a razor blade using a slight scraping motion. Any pellets with large (>1 millimeter) gouges, flakes, or large cracks were usually discarded. Using calipers capable of measuring hundredths of a millimeter or thousandths of an inch, a measurement of the thickness and diameter of each pellet was accomplished. Subsequently, there was brushed a thin uniform, about 1 to about 3 millimeter thick, coat of silver print (Silver Print GC Electronics #22-202) on one side of each pellet; and the silver print was permitted to dry for about 5 to about 10 minutes, then the silver print was applied to the other side of the pellet. The resulting pellets were allowed to stand as is for about 30 minutes to permit volatiles to dissipate.

Using a resistivity cell in conjunction with a Keithly model 617 Programmable Electrometer the resistivity of the pellets were measured. Volume resistivity was then calculated for each pellet.

| EEONOMER ® 200 F | | Graphite | |
|---|---|---|---|
| Additive | Resistivity | Additive | Resistivity |
| (Percent by Vol) | (W-cm) | (Percent by Vol) | (W-cm) |
| 3 | 1.2E + 12 | 3 | 4.8E + 02 |
| 5 | 3.3E + 06 | 5 | 1.9E + 01 |
| 7 | 2.1E + 02 | 7 | 7.8E + 00 |
| 9 | 3.6E + 01 | 9 | 6.8E + 00 |

W = ohm
$Volume Resistivity ( ohm - cm ) = R ( \frac{A}{t} )$
where
R = Measured Resistance in Ohms
A = the area of the circular electroded surface of the pellet in cm²
t = The thickness of the pellet in centimeters.

Also, for example, R is equal to about 1 E+00 to about 1 E+06 ohms depending on the amount of graphite added to the pellet; A is equal to about 12.7 to about 12.8 centimeters (this diameter is based on the die in which the pellets are pressed and will not vary substantially; this variation is based on measurement variation and not the part to part difference, hence the tight tolerance); and t is equal to about 1.8 to 2.7 centimeters. The resistivity like 1.2E+12 refers to that the +12 is exponential.

### EXAMPLE II

### Preparation of 0.1 Ratio (by Weight) of Graphite/Polymethylmethacrylate Coated Carrier at 0.6 Percent Coating Weight

There was prepared by mixing in a 5 liter M5R blender (available from Littleford Day Inc., Florence, Ky.) a polymer premix of 9 pph by weight of Graphine EEONOMER® 200G (graphite—available commercially from Eeonyx Inc., Pinole, Calif.), and 91 pph by weight of polymethylmethacrylate (MP-116 available commercially from Soken Chemical & Engineering Co. Ltd., Tokyo, Japan). The polymer premix product was blended in the M5R blender at 25 percent volume loading for 4 minutes at 400 rpm.

Subsequently, a core/polymer premix was produced by combining 27.2 grams of the above generated resulting polymer premix with 10 pounds of 82 micron volume median diameter irregular steel core (obtained from Hoeganaes), with the core size determined in this and all following carrier Examples by a standard laser diffraction technique, then mixed in a 5 liter M5R blender (available from Littleford Day Inc., Florence, Ky.). The mixing was accomplished at 220 rpm for a period of 10 minutes. There resulted uniformly distributed and electrostatically attached the polymer premix on the steel core as determined by visual observation.

The resulting mixture was then processed in a three inch rotary furnace (obtained from Harper International Inc., Lancaster N.Y.) under the conditions of 6 rpm, feedrate of 32 grams/minute, and at a furnace angle of 0.4 degree. The conditions presented (rpm, feedrate, and angle) are some of the primary factors that drive the residence time and volume loading which are examples of the desired parameters for fusing the coating to the carrier core. Residence time is calculated as the quotient of the weight of the core/polymer mixture in the muffle section (heated section) of the kiln and the feedrate of the materials. The resulting residence time of the above obtained particles at the above stated setpoints was 31.6 minutes. The volume loading of the kiln at the above stated setpoints was 8.5 percent of the total volume of the kiln. The peak bed temperature of the resulting product or materials (coated carrier) under these conditions was 426° F., thereby causing the polymer mix to melt and fuse to the core. There resulted a continuous uniform polymer coating on the core.

The carrier powder coating process used is described, for example, in U.S. Pat. Nos. 4,935,326; 5,015,550 4,937,166; 5,002,846 and 5,213,936, the disclosures of each of which are totally incorporated herein by reference.

The final product was comprised of the above carrier core with a total of 0.6 percent by weight of the aforementioned coating of poly(methylmethacrylate) and EEONOMER® 200G (graphite) and comprised of 9 weight percent of graphite and 91 weight percent of poly(methylmethacrylate). The weight percent of this carrier was determined in this and all following carrier Examples by dividing the difference between the weights of the fused carrier and the carrier core by the weight of the fused carrier.

A developer composition was then prepared in this and all following Examples by mixing 100 grams of the above prepared coated carrier with 4.5 grams of an 8.45 micron volume median diameter (volume average diameter) cyan toner, comprised of Polytone-C Cyan 15:3 Pigment, the polytone being a partially crosslinked (about 32 percent) polyester resin obtained by the reactive extrusion of a linear bisphenol A propylene oxide fumarate polymer. The toner composition contained as external surface additives 1.93 percent by weight of a hydrophobic 40 nanometer size (size refers to the diameter) titania, 3.36 percent by weight of a 30 nanometer size hydrophobic silica, 0.1 percent by weight of a 12 nanometer size (diameter) hydrophobic silica, and 0.5 weight percent of zinc stearate. The final toner composition had a melt flow index of 9. This developer was conditioned for 1 hour at 50 percent RH and 70° F. The resulting developer was shaken on a paint shaker at 715 rpm in a 4 ounce jar, and a 0.30 gram coated carrier sample was removed after 20 minutes. Thereafter, the triboelectric charge on the carrier particles was determined by the known Faraday Cage process, and there was measured on the carrier a negative charge of 40 microcoulombs per gram. Further, the conductivity of the carrier as determined by forming a 0.1 inch magnetic brush of the carrier particles, and measuring the conductivity by imposing a 30 volt potential across the brush was 1.73×10⁻⁸ (ohm-cm)⁻¹. Therefore, these carrier particles were conductive.

### EXAMPLE III

### Preparation of 0.1 Ratio (by Weight) of Graphite/Polymethylmethacrylate Coated Carrier at 1 Percent Coating Weight

There was prepared by mixing in a 5 liter M5R blender (available from Littleford Day Inc., Florence, Ky.) a polymer premix of 9 pph by weight of Graphine EEONOMER® 200G (graphite—available commercially from Eeonyx Inc., Pinole, Calif.), and 91 pph by weight of polymethylmethacrylate (MP-116 available commercially from Soken Chemical & Engineering Co. Ltd., Tokyo, Japan). The polymer premix product was blended in the above M5R blender at 25 percent volume loading for 4 minutes at 400 rpm.

Subsequently, a core/polymer premix was produced by combining 45.4 grams of the above generated resulting polymer premix with 10 pounds of 82 micron volume median diameter irregular steel core (obtained from Hoeganaes), and then mixing in a 5 liter M5R blender (available from Littleford Day Inc., Florence, Ky.). The mixing was accomplished at 220 rpm for a period of 10 minutes. There resulted uniformly distributed and electrostatically attached polymer premix on the steel core as determined by visual observation.

The core/polymer premix composition was then fused into carrier as described in Carrier Example II. The resulting residence time was 33.1 minutes. The volume loading of the kiln was approximately 8.9 percent of the total volume of the kiln. The peak bed temperature of the carrier materials under these conditions was 425° F., thereby causing the polymer to melt and fuse to the above core. This resulted in a continuous uniform polymer coating on the core.

The final product was comprised of a carrier core with a total of 1 percent by weight of polymer coating on the surface. The polymer coating contained 9 weight percent of EEONOMER® 200G graphite and 91 weight percent of poly(methylmethacrylate).

A developer composition was then prepared as described in carrier Example II. Thereafter, the triboelectric charge on the carrier particles was determined by the known Faraday Cage process, and there was measured on the carrier a negative charge of 40.6 microcoulombs per gram. The conductivity of the carrier as determined by forming a 0.1 inch magnetic brush of the carrier particles, and measuring the conductivity by imposing a 30 volt potential across the brush was 4.21×10⁻⁹ (ohm-cm)⁻¹.

### EXAMPLE IV

### Preparation of 0.05 Ratio (by Weight) of Graphite/Polymethylmethacrylate Coated Carrier at 1.05 Percent Coating Weight

There was prepared by mixing in a 10 liter Henschel blender (available from Henschel Mixers America, Inc. Model FM-10) a high intensity polymer premix of 5 pph by weight of EEONOMER® 200G (graphite—available commercially from Eeonyx Inc., Pinole, Calif.), and 95 pph by weight of polymethylmethacrylate (MP-116 available commercially from Soken Chemical & Engineering Co. Ltd., Tokyo, Japan). The polymer premix product was blended in the Henschel blender at 50 percent volume loading for 1 minute at 3,000 rpm.

Subsequently, a core/polymer premix was produced by combining 66.7 grams of the above generated resulting polymer premix with 10 pounds of 82 micron volume median diameter irregular steel core (obtained from Hoeganaes), and then mixing in a 5 liter M5R blender (available from Littleford Day Inc., Florence, Ky.). The mixing was accomplished at 220 rpm for a period of 10 minutes. There resulted, uniformly distributed and electrostatically attached, the polymer premix on the steel core as determined by visual observation.

The core/polymer premix composition was then fused into carrier as described in carrier Example II resulting in a 32.3 minute residence time and 8.7 percent volume loading of the kiln. The peak bed temperature of the carrier materials under these conditions was 418° F., thereby causing the polymer to melt and fuse to the core. This resulted in a continuous uniform polymer coating on the core.

The final product was comprised of a carrier core with a total of 1.05 percent by weight of polymer coating on the surface. The polymer coating contained 5 weight percent of EEONOMER® 200G and 95 weight percent of poly(methylmethacrylate).

A developer composition was then prepared as described in carrier Example II. Thereafter, the triboelectric charge on the carrier particles was determined by the known Faraday Cage process, and there was measured on the carrier a negative charge of 42 microcoulombs per gram. The conductivity of the carrier as determined by forming a 0.1 inch magnetic brush of the carrier particles, and measuring the conductivity by imposing a 30 volt potential across the brush was 2.92×10⁻¹¹ (ohm-cm)⁻¹. Therefore, these carrier particles were conductive.

### EXAMPLE V

### Preparation of 0.15 Ratio (by Weight) of Graphite/Polymethylmethacrylate Coated Carrier at 1.15 Percent Coating Weight

There was prepared by mixing in a 10 liter Henschel blender (available from Henschel Mixers America, Inc. Model FM-10) a high intensity polymer premix of 13 pph by weight of EEONOMER® 200G (graphite—available commercially from Eeonyx Inc., Pinole, Calif.), and 87 pph by weight of polymethylmethacrylate (MP-116 available commercially from Soken Chemical & Engineering Co. Ltd., Tokyo, Japan). The polymer premix product was blended in the Henschel blender at 50 percent volume loading for 1 minute at 3,000 rpm.

Subsequently, a core/polymer premix was produced by combining 73 grams of the above generated resulting polymer premix with 10 pounds of 82 micron volume median diameter irregular steel core (obtained from Hoeganaes), followed by mixing in a 5 liter M5R blender (available from Littleford Day Inc., Florence, Ky.). The mixing was accomplished at 220 rpm for a period of 10 minutes. There resulted, uniformly distributed and electrostatically attached, the above polymer premix on the steel core as determined by visual observation.

The core/polymer premix composition was then fused into carrier as described in carrier Example II resulting in a 29.4 minute residence time and 7.9 percent volume loading of the kiln. The peak bed temperature of the carrier materials under these conditions was 418° F., thereby causing the polymer to melt and fuse to the core. This resulted in a continuous uniform polymer coating on the core.

The final product was comprised of a carrier core with a total of 1.15 percent by weight of polymer coating on the surface. The polymer coating contained 13 weight percent of EEONOMER® 200G and 87 weight percent of poly(methylmethacrylate).

A developer composition was then prepared as described in carrier Example II. Thereafter, the triboelectric charge on the carrier particles was determined by the known Faraday Cage process, and there was measured on the carrier a negative charge of 40.7 microcoulombs per gram. Further, the conductivity of the carrier as determined by forming a 0.1 inch magnetic brush of the carrier particles, and measuring the conductivity by imposing a 30 volt potential across the brush was 2.44×10⁻¹⁰ (ohm-cm)⁻¹. Therefore, these carrier particles were conductive.

### EXAMPLE VI

### Preparation of 0.2 Ratio (by Weight) of Graphite/Polymethylmethacrylate Coated Carrier at 1.2 Percent Coating Weight

There was prepared by mixing in a 10 liter Henschel blender (available from Henschel Mixers America, Inc. Model FM-10) a high intensity polymer premix of 17 pph by weight of EEONOMER® 200G (graphite—available commercially from Eeonyx Inc., Pinole, Calif.), and 83 pph by weight of polymethylmethacrylate (MP-116 available commercially from Soken Chemical & Engineering Co. Ltd., Tokyo, Japan). The polymer premix product was blended in the Henschel blender at 50 percent volume loading for 1 minute at 3,000 rpm.

Subsequently, a core/polymer premix was produced by combining 76.2 grams of the above generated resulting polymer premix with 10 pounds of 82 micron volume median diameter irregular steel core (obtained from Hoeganaes), and then mixed in a 5 liter M5R blender (available from Littleford Day Inc., Florence, Ky.). The mixing was accomplished at 220 rpm for a period of 10 minutes. There resulted, uniformly distributed and electrostatically attached, the aforementioned polymer premix on the steel core as determined by visual observation.

The core/polymer premix composition was then fused into carrier as described in carrier Example II resulting in a 31.4 minute residence time and 8.4 percent volume loading of the kiln. The peak bed temperature of the carrier materials under these conditions was 413° F., thereby causing the polymer to melt and fuse to the core. This resulted in a continuous uniform polymer coating on the core.

The final product was comprised of a carrier core with a total of 1.2 percent by weight of polymer coating on the surface. The polymer coating of poly(methylmethacrylate) with EEONOMER® 200G contained 17 weight percent of EEONOMER® 200G, and 83 weight percent of poly(methylmethacrylate).

A developer composition was then prepared as described in carrier Example II. Thereafter, the triboelectric charge on the carrier particles was determined by the known Faraday Cage process, and there was measured on the carrier a negative charge of 38.1 microcoulombs per gram. Further, the conductivity of the carrier as determined by forming a 0.1 inch magnetic brush of the carrier particles, and measuring the conductivity by imposing a 30 volt potential across the brush was 2.55×10⁻¹⁰ (ohm-cm)⁻¹. Therefore, these carrier particles were conductive.

### EXAMPLE VII

### Preparation of 0.4 Ratio (by Weight) of Graphite/Polymethylmethacrylate Coated Carrier at 1.4 Percent Coating Weight

There was prepared by mixing in a 10 liter Henschel blender (available from Henschel Mixers America, Inc. Model FM-10) a high intensity polymer premix of 29 pph by weight of EEONOMER® 200G (graphite—available commercially from Eeonyx Inc., Pinole, Calif.), and 71 pph by weight of polymethylmethacrylate (MP-116 available commercially from Soken Chemical & Engineering Co. Ltd., Tokyo, Japan). The polymer premix product was blended in the Henschel blender at 50 percent volume loading for 1 minute at 3,000 rpm.

Subsequently, a core/polymer premix was produced by combining 88.9 grams of the above generated resulting polymer premix with 10 pounds of 82 micron volume median diameter irregular steel core (obtained from Hoeganaes), followed by mixing in a 5 liter M5R blender (available from Littleford Day Inc., Florence, Ky.). The mixing was accomplished at 220 rpm for a period of 10 minutes. There resulted, uniformly distributed and electrostatically attached, the above polymer premix on the steel core as determined by visual observation.

The core/polymer premix composition was then fused into carrier as described in (by repeating the appropriate process of carrier Example II) carrier Example II resulting in a 32.1 minute residence time and 8.6 percent volume loading of the kiln. The peak bed temperature of the materials under these conditions was 423° F., thereby causing the polymer to melt and fuse to the core. This resulted in a continuous uniform polymer coating on the core.

The final product was comprised of a carrier core with a total of 1.4 percent by weight of polymer coating on the surface. The polymer coating of poly(methylmethacrylate) with EEONOMER® 200G contained 29 weight percent of EEONOMER® 200G, and 71 weight percent of poly(methylmethacrylate).

A developer composition was then prepared as described in carrier Example II. Thereafter, the triboelectric charge on the carrier particles was determined by the known Faraday Cage process, and there was measured on the carrier a negative charge of 38.6 microcoulombs per gram. Further, the conductivity of the carrier as determined by forming a 0.1 inch magnetic brush of the carrier particles, and measuring the conductivity by imposing a 30 volt potential across the brush was 4.92×10⁻¹⁰ (ohm-cm)⁻¹. Therefore, these carrier particles were conductive.

### EXAMPLE VIII

### Preparation of 0.2 Ratio (by Weight) of Graphite/Polymethylmethacrylate Coated Carrier at 0.15 Percent Coating Weight

There was prepared by mixing in a 10 liter Henschel blender (available from Henschel Mixers America, Inc. Model FM-10) a high intensity polymer premix of 17 pph by weight of EEONOMER® 200G (graphite—available commercially from Eeonyx Inc., Pinole, Calif.), and 83 pph by weight of polymethylmethacrylate (MP-116 available commercially from Soken Chemical & Engineering Co. Ltd., Tokyo, Japan). The polymer premix product was blended in the Henschel blender at 50 percent volume loading for 1 minute at 3,000 rpm.

Subsequently, a core/polymer premix was produced by combining 9.5 grams of the above generated resulting polymer premix with 10 pounds of 82 micron volume median diameter irregular steel core (obtained from Hoeganaes), followed by mixing in a 5 liter M5R blender (available from Littleford Day Inc., Florence, Ky.). The mixing was accomplished at 220 rpm for a period of 10 minutes. There resulted, uniformly distributed and electrostatically attached, polymer premix on the steel core as determined by visual observation.

The core/polymer premix composition was then fused into carrier as described in carrier Example II, resulting in a 32.2 minute residence time and 8.7 percent volume loading of the kiln. The peak bed temperature of the materials under these conditions was 432° F., thereby causing the polymer to melt and fuse to the core. This resulted in a continuous uniform polymer coating on the core.

The final product was comprised of a carrier core with a total of 0.15 percent by weight of polymer coating on the surface. The polymer coating of poly(methylmethacrylate) with EEONOMER® 200G contained 17 weight percent of EEONOMER® 200G, and 83 weight percent of poly(methylmethacrylate).

A developer composition was then prepared as described in carrier Example II. Thereafter, the triboelectric charge on the carrier particles was determined by the known Faraday Cage process, and there was measured on the carrier a negative charge of 36.6 microcoulombs per gram. Further, the conductivity of the carrier as determined by forming a 0.1 inch magnetic brush of the carrier particles, and measuring the conductivity by imposing a 30 volt potential across the brush was 4.02×10⁻⁸ (ohm-cm)⁻¹. Therefore, these carrier particles were conductive.

The claims, as originally presented and as they may be amended, encompass variations, alternatives, modifications, improvements, equivalents, and substantial equivalents of the embodiments and teachings disclosed herein, including those that may be presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

What is claimed is:

1. Carrier comprised of a core, at least one polymer coating, and wherein said coating contains graphite.

2. A carrier in accordance with claim 1 wherein the polymer coating is comprised of a mixture of polymers.

3. A carrier in accordance with claim 2 wherein the mixture is comprised of two polymers.

4. A carrier in accordance with claim 2 wherein the mixture is comprised of two polymers not in close proximity in the triboelectric series.

5. A carrier in accordance with claim 2 wherein the mixture is comprised of from about 2 polymers to about 7 polymers.

6. A carrier in accordance with claim 1 wherein the graphite is dispersed in said at least one polymer coating, and wherein said at least one is from 1 to about 3.

7. A carrier in accordance with claim 1 wherein the ratio of graphite to polymer coating is from about 5/95 to about 40/60.

8. A carrier in accordance with claim 1 wherein said graphite possesses a primary particle size diameter of from about 1 to about 3 microns.

9. A carrier in accordance with claim 1 wherein said graphite possesses a primary particle size of from about 0.5 to about 10 microns, and said at least one polymer is comprised of two polymers comprised of a first and a second polymer, and wherein the first polymer is present in an amount of from about 60 to about 40 weight percent, and the second polymer is present in an amount of from about 40 to about 60 weight percent.

10. A carrier in accordance with claim 1 wherein the said at least one polymer is comprised of two polymers comprised of a first and second polymer, and wherein the first polymer is present in an amount of from about 1 to about 99 weight percent, and the second polymer is present in an amount of from about 99 to about 1 weight percent.

11. A carrier in accordance with claim 1 wherein said graphite is present in an amount of from about 5 percent by weight to about 70 percent by weight based on the weight percent of the total of said polymer coating and said graphite, and wherein said at least one polymer is one.

12. A carrier in accordance with claim 1 wherein said graphite is present in an amount of at least one of from about 5 percent by weight to about 25 percent by weight, and from about 10 percent by weight to about 20 percent by weight.

13. A carrier in accordance with claim 1 wherein said core diameter is from about 30 to about 100 microns.

14. A carrier in accordance with claim 1 wherein said core is iron, steel, or a ferrite.

15. A carrier in accordance with claim 1 wherein said coating is a styrene polymer.

16. A carrier in accordance with claim 1 wherein said polymer coating is at least one of polyvinylidenefluoride, polyethylene, polymethyl methacrylate, polytrifluoroethylmethacrylate, copolyethylene vinylacetate, copolyvinylidenefluoride, tetrafluoroethylene, polystyrene, tetrafluoroethylene, polyvinyl chloride, sodium lauryl sulfate (SLS) polymethylmethacrylate and polyvinyl acetate, and said core is a suitable metal containing substance.

17. A carrier in accordance with claim 1 wherein said polymer coating is comprised of a mixture of polymethylmethacrylate and polyvinylidene fluoride, wherein said polymethacrylate is present in an amount of from about 60 to about 40 weight percent, and said polyvinylidene fluoride is present in an amount of from about 40 to about 60 weight percent.

18. A carrier in accordance with claim 1 wherein said polymer coating is comprised of a mixture of polymethylmethacrylate, and polyvinylidene fluoride, wherein said polymethacrylate is present in an amount of from about 1 to about 99 weight percent, and said polyvinylidene fluoride is present in an amount of from about 99 to about 1 weight percent.

19. A carrier in accordance with claim 1 wherein said polymer coating is present in an amount of from about 0.2 to about 10 percent by weight of said carrier.

20. A carrier in accordance with claim 1 with a conductivity of from about 10⁻¹⁵ to about 10⁻⁶ (ohm-cm)⁻¹, and wherein said core is a metal containing material.

21. A carrier in accordance with claim 1 with a triboelectric charge value of from about −60 to about 60 microcoulombs/gram, and a conductivity of from about 10⁻¹² to about 10⁻⁸ (ohm-cm)⁻¹.

22. A process for the preparation of carrier particles comprised of mixing carrier core, and a graphite containing polymer resulting in a polymer coating contained on the carrier core, and said graphite present in said polymer coating.

23. A developer comprised of toner and carrier comprised of a core, at least one polymer coating, and wherein said coating contains graphite.

24. A developer in accordance with claim 23 wherein said toner is comprised of a thermoplastic resin, and colorant, and said at least one is one.

25. A developer in accordance with claim 23 wherein said toner contains at least one of a charge additive, a wax, surface additives, and mixtures thereof.

26. A carrier in accordance with claim 23 wherein said core contains thereover a graphite containing polymer, and said at least one is one.

27. A carrier in accordance with claim 26 wherein the ratio of graphite to polymer coating is from about 10/90 to about 20/80, and said core is a suitable metal containing substance, and said at least one polymer is from 1 to 2.

28. A carrier in accordance with claim 26 wherein the ratio of graphite to polymer coating is from about 5/95 to about 40/60, and said at least one polymer is from 1 to 2.

29. A carrier in accordance with claim 26 wherein the at least one polymer is one and is comprised of a polymethylmethacrylate.

30. A carrier in accordance with claim 26 wherein the graphite particle diameter size is from about 300 nanometers to about 7 microns.

31. A carrier in accordance with claim 26 wherein said graphite particle diameter size is from about 1 to about 5 microns.

32. A carrier in accordance with claim 26 wherein said polymer coating is present in an amount of from about 1 to about 5 percent by weight of said carrier components, wherein said graphite particle diameter size is from about 1 to about 3 microns, and wherein said core is a ferrite or an iron containing powder, and said at least one polymer is one.
